(19) United States
(12) Patent Application Publication
(10) Pub. No.: US 2026/0370311 A1
(43) Pub. Date: Nov. 19, 2026

(54) CONFIGURING MOBILE BASE STATIONS WITH SPECIALIZED CAPABILITIES

(71) Applicant: Telefonaktiebolaget LM Ericsson (publ), Stockholm (SE)

(72) Inventors: Muhammad Ali KAZMI, SUNDBYBERG (SE); Anders NORDLÖW, HÄSSELBY (SE)

(73) Assignee: Telefonaktiebolaget LM Ericsson (publ), Stockholm (SE)

(21) Appl. No.: 19/148,383

(22) PCT Filed: Feb. 24, 2023
(86) PCT No.: PCT/IB2023/051735

§ 371 Date: Jul. 16, 2025

(51) Int. Cl. H04B 7/185; H04L 41/0803

(52) U.S. Cl. CPC H04B 7/18502; H04L 41/0803

(57) ABSTRACT

A method performed by a node in a wireless communication network includes determining a need for a mobile base station to provide wireless communication services to a user equipment, UE, in a target geographic area, and transmitting a request message to a configuration node that is responsible for configuring mobile base stations in the target geographic area. The request message requests the configuration node to configure at least one mobile base station out of a set of mobile base stations for serving the UE in the target geographic area. Related network nodes and computer program products are disclosed.

### TECHNICAL FIELD

The present disclosure relates to wireless communications networks, and in particular to wireless networks that support non-terrestrial deployment of network equipment.

### BACKGROUND

There is a growing interest to integrate mobile communication platforms into wireless networks. One approach is to use autonomous vehicles, such as helicopter drones, to carry base stations, which enables a base station to physically move to serve users.

The market is at an early stage where research is progressing, and publications are being developed. 3GPP technologies, such as 5G and its successors, will open opportunities to advance aerial communication including mobile base stations. There is an interest to develop necessary standard support for aerial vehicles in NR.

Spaceborne vehicles that may be involved in wireless communications include satellites, including Low Earth Orbiting (LEO) satellites, Medium Earth Orbiting (MEO) satellites, Geostationary Earth Orbiting (GEO) satellites, and Highly Elliptical Orbiting (HEO) satellites. Airborne vehicles that may be involved in wireless communications may include High Altitude Platforms (HAPs) encompassing Unmanned Aircraft Systems (UAS) including Lighter than Air UAS (LTA) and Heavier than Air UAS (HTA). Such vehicles may operate at altitudes typically between 8 and 50 km and may be quasi-stationary.

Various use cases for integration of air- and spaceborne vehicles, and the corresponding service requirements for such integration, have been identified. In particular, air- and spaceborne vehicle integration may help to address mobile broadband needs in unserved/underserved areas, as well as applications such as public safety needs, airplane connectivity and railway communication service requirements applicable to satellite access.

Some efforts have been made to study the channel model for non-terrestrial networks, to define deployment scenarios and parameters and to identify the key potential impacts on NR, as well as to identify solutions that will enable NR to support non-terrestrial networks.

### SUMMARY

A method performed by a node in a wireless communication network includes determining a need for a mobile base station to provide wireless communication services to a UE in a target geographic area, and transmitting a request message to a configuration node that is responsible for configuring mobile base stations in the target geographic area. The request message requests the configuration node to configure at least one mobile base station out of a set of mobile base stations for serving the UE in the target geographic area.

The method may further include receiving a response message from the configuration node indicating whether or not the request to configure the at least one mobile base station was successful.

The request message may include information about a mobile base station that is to be configured by the configuration node. The information may include an identifier of the mobile base station that is to be configured by the configuration node.

The request message may indicate a type of communication service expected to be provided by the at least one mobile base station to the UE in the target geographic area. The type of communication service expected to be provided by the mobile base station may include an enhanced mobile broadband (eMBB) service, an ultra-reliable low-latency communication service, a machine type communication service, a location service, a vehicle to anything (V2X) communication service, a national security and public safety (NSPS) service, a massive machine type communication service, a low-latency high-rate service, a cloud gaming service, an extended reality service, an advance duplex operational service, a sensing service and/or a joint communication and sensing (JCAS) service.

The request message may indicate the target geographic area, a type of mobile base station needed, a reference time at which the at least one mobile base station should start providing communication services to the UE in the target geographic area, a time duration during which the at least one mobile base station should provide communication services to the UE in the target geographic area, and/or a mobility profile that is needed for the at least one mobile base station to provide communication services to the UE in the target geographic area.

The method may further include receiving additional information from an information node about the at least one mobile base station, a type of mobile base station to be configured, and/or a type of service to be provided by the at least one mobile base station. The additional information may be included in the request message transmitted to the configuration node.

The node may be one of the UE and a network node.

A method performed by a node in a wireless communication network according to some embodiments includes receiving, at a configuration node that is responsible for configuring mobile base stations in a target geographic area, a request message from a requesting node. The request message requests the configuration node to configure at least one mobile base station out of a set of mobile base stations to provide wireless communication services to a UE in the target geographic area. The method further includes configuring the at least one mobile base station to provide wireless communication services to the UE in the target geographic area.

The method may further include transmitting a response message to the requesting node confirming configuration of the at least one mobile base station.

The request message may include information about a mobile base station that is to be configured by the configuration node, and the method may further include selecting the at least one mobile base station to provide communication services to the UE based on the information.

The method may further include transmitting a secondary request to a secondary configuration node requesting the secondary configuration node to configure the at least one mobile base station.

The method may further include executing a procedure in response to receiving the request message, wherein the procedure may include selecting the at least one mobile base station based on a mapping table, activating or preparing the at least one mobile base station, configuring or directing the at least one mobile base station to move to the target geographic area, and/or requesting a secondary node to configure the at least one mobile base station.

The mapping table may define the set of mobile base stations and the one or more type of communication services provided by each mobile base station of the set of mobile base stations.

The mapping table may define the set of mobile base stations and respective durations of operation and/or maximum speed limits of the mobile base stations.

The requesting node may be one of the UE and a network node.

Some embodiments provide a network node including a processing circuit, a transceiver coupled to the processing circuit, and a memory coupled to the processing circuit, wherein the memory may include computer readable program instructions that, when executed by the processing circuit, cause the network node to perform operations according to any of the foregoing embodiments.

Some embodiments provide a computer program product comprising a non-transitory medium storing computer program instructions that, when executed by a processing circuit, cause the processing circuit to perform operations according to any of the foregoing embodiments.

### BRIEF DESCRIPTION OF THE DRAWINGS

FIG. 1 illustrates a communication system including a mobile base station.

FIGS. 2 to 5 illustrate systems/methods for configuring mobile base stations in communication systems according to some embodiments.

FIGS. 6 and 7 illustrate operations for configuring mobile base stations in communication systems according to some embodiments.

FIG. 8 illustrates an example of a communication system in accordance with some embodiments.

FIG. 9 illustrates an example of a user equipment (UE) in accordance with some embodiments.

FIG. 10 illustrates an example of a network node in accordance with some embodiments.

### DETAILED DESCRIPTION OF EMBODIMENTS

As described above, there is a growing interest to incorporate air- and spaceborne vehicles into wireless communication network infrastructure. There currently exist certain challenges with doing so, however. For example, a mobile base station (MBS) or similar aerial vehicle may be used to serve user equipment (UEs) which cannot be served by traditional fixed base stations, or otherwise to fill in coverage gaps in a network. However, with the adoption of 5G and later technologies, there is an increasing proliferation of services an MBS may have to implement. Implementing such complex features in an MBS may increase the cost, complexity and power consumption of the device. Furthermore, the management of an MBS is highly specialized because unlike a fixed base station (BS), an MBS must perform complex and unique functions such aerodynamic movement, fueling, regular service, etc., in addition to managing wireless communications.

Currently, a primary focus of research is on how an MBS can adequately provide coverage to UEs in a network. However, there is currently no mechanism for managing the deployment of MBSs in a wireless communication network.

Certain aspects of the disclosure and their embodiments may provide solutions to these or other challenges. Some embodiments described herein provide new signaling mechanisms that may facilitate the efficient use of MBS, reduce overall costs for operators, enhance the service quality and/or enhance the availability of the MBS. This in turn may ensure that the MBS can provide adequate quality of service (QoS) to the UEs. In particular, some embodiments provide methods performed by network nodes for requesting and configuring one out of a set of specialized mobile base station (sMBS) for managing or serving at least one UE.

Some embodiments provide a method in a first node of requesting a second node for configuring at least one out of the set of the sMBSs for serving at least one UE. The first node may, for example, be a UE, a core network node, a radio network node, etc. The second node may be referred to as a distributed management node, or DMN. In response to receiving the request, the DMN selects one of the sMBSs associated with the requested specialized function and configures the selected sMBS to serve at least one UE.

As an example, the set of sMBSs may include one general purpose MBS and another MBS that is capable of performing a specialized function, such as an advance beam management function, a positioning related function, etc.

The mechanism described herein allows the management of sMBS by an entity that specializes in MBS management, but can serve UEs in any operator's network by means of standardized signaling between the operator network and the DMN. This in turn may enable network operators to outsource MBS management, thereby reducing the cost and complexity of managing MBSs.

Certain embodiments may provide one or more technical advantages. For example, a method according to some embodiments may facilitate an MBS implementation, since not all MBSs have to implement all complex functionalities.

A method according to some embodiments may enhance the configuration and management of the MBS and improve the overall performance of the network.

A signaling mechanism according to some embodiments may allow operators to outsource the complex task of managing MBS to service providers specializing in MBS. This in turn allows an operator to access a particular type of MBS upon demand.

Some of the embodiments contemplated herein will now be described more fully with reference to the accompanying drawings. Embodiments are provided by way of example to convey the scope of the subject matter to those skilled in the art.

In an aerial communication system, stationary base stations interact with mobile base stations. The stationary base stations may be responsible for basic coverage of a target area. The introduction of mobile base stations can complement the existing stationary base stations by providing an ability to handle variations in load and secure performance. The wireless system may support beam optimization for antenna beams used in the target area.

The term “base station” as used herein refers to a stationary BS whose geographical location does not change over time. Unless stated otherwise, the term BS refers to a conventional stationary BS. A BS may also be referred to as a fixed or immovable BS. The BS can be any type of network node which communicates with a UE and/or with another network node.

The term “mobile base station (MBS)” refers to a BS whose geographical location may change over time, or a BS that at least has the capability to change its geographical location. A mobile base station may include a vehicle configured to travel over land, water and/or air. For example, an MBS may be a drone helicopter having necessary circuitry and aerodynamic capability for it to physically fly or move in the air or in 3-dimensional space in any direction. Alternatively, an MBS may be a wheeled land vehicle or a boat that moves in 2-dimensional space. An MBS may however also remain stationary for certain time-period. An MBS may therefore be described as quasi-stationary in some cases.

An MBS can be an independent node in the wireless communication system, or it can be located or housed in another node or device (e.g., on a satellite). The movement of the MBS may be controlled autonomously or by another node. In some cases, the movement of the MBS may be based on pre-configured information, such as a planned race. An MBS may also be referred to using other terminology, such as a non-stationary BS, a mobile BS, movable BS, a high altitude platform station (HAPS), an air to ground (ATG) serving node, etc. Unless stated otherwise, the term MBS used in the present description refers to a ‘non-stationary BS’. An MBS can be any type of ‘network node’ which communicates with a UE and/or with another network node (e.g., with a BS).

Examples of network nodes are NodeB, MeNodeB, SeNodeB, gNodeB, sgNodeB, a network node belonging to master cell group (MCG) or secondary cell group (SCG), base station (BS), multi-standard radio (MSR) radio node such as MSR BS, eNodeB, gNodeB, network controller, radio network controller (RNC), base station controller (BSC), relay, donor node controlling relay, base transceiver station (BTS), integrated access and backhaul (IAB) node, access point (AP), transmission points, transmission nodes, backhaul node, RRU, RRH, nodes in distributed antenna system (DAS), core network node (e.g. MSC, MME, AMF, SMF, etc.), O&M node, OSS node, SON node, positioning node (e.g. E-SMLC), test equipment, etc.

In some embodiments the term “user equipment” (UE) is used and it refers to any type of wireless device communicating with a network node and/or with another UE in a cellular or mobile communication system. A UE can also be an aerial vehicle, which can be any type of flying object equipped with a UE. Examples of UEs are target device, device to device (D2D) UE, machine type UE or UE capable of machine to machine (M2M) communication, PDA, tablet computer, mobile terminals, smart phone, laptop embedded equipped (LEE), laptop mounted equipment (LME), USB dongles, ProSe UE, V2V UE, V2X UE, MTC UE, eMTC UE, further-enhanced MTC (FeMTC) UE, UE Cat 0, UE Cat M1, narrowband Internet of Things (NB-IoT) UE, UE Cat NB1, aerial UE (AUE) (e.g. UE operating above certain height). A UE can have the form of, or be carried in, an autonomous vehicle, such as a helicopter drone or other vehicle.

In some embodiments, the term “node” may refer to a UE or a network node.

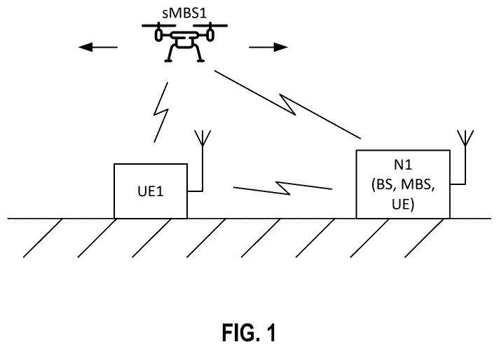

Referring to FIG. 1, in an example embodiment, a first UE (UE1) needs to be served or managed by a radio network for wireless operation starting from certain time instance (T0). T0 can be the current time instance (Tc) or it can be a future time instance (Tf) starting from a reference time (Tr). In one example Tr can be a global time such as Coordinated Universal Time (UTC), GPS time, etc. In another example Tr can be a time when a request for sending a sMBS is sent. In a special case, Tr=Tc. In one example, UE1 is currently being served by a radio node N1. In this case UE1 may be about to lose coverage from the radio node N1 or it may still retain the coverage from the radio node N1. In another example, UE1 has recently been served by the radio node N1 but is no longer being served by the radio node N1, for example, due to loss of the coverage. In both exemplary scenarios UE1 needs to be served by an MBS with a special capability (sMBS1). In one example the radio node N1 serving UE1 or that has served UE1 is a radio network node (e.g., a base station, access point etc.).

In one example, the radio node Node1 serving UE1 is a BS (BS1) or an MBS (MBS1). In another example the radio node N1 serving UE1 or that has served UE1 is a second UE (UE2), in which case UE1 and UE2 are D2D capable.

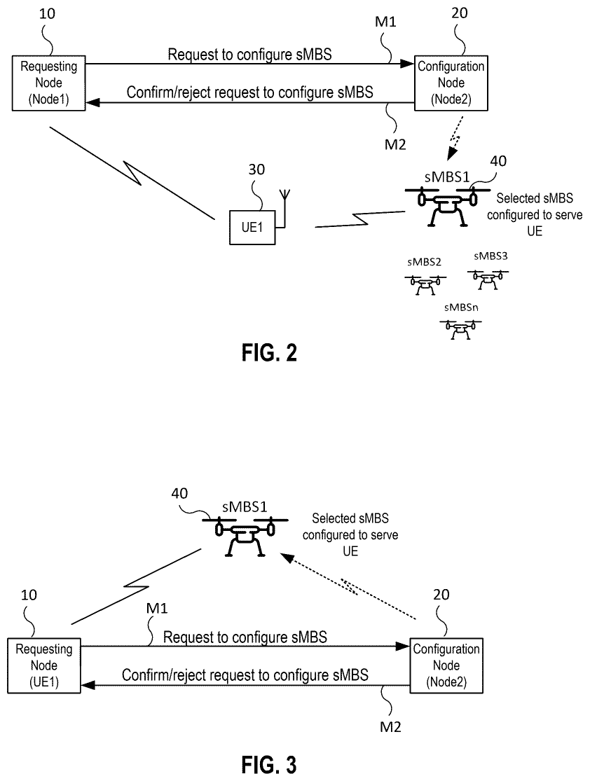

Referring to FIG. 2, according to some embodiments, a requesting node 10 (Node1) transmits a message M1 to an MBS configuration node 20 (Node2), requesting the configuration node 20 to configure at least one sMBS 40 (sMBS1) out of a set of sMBSs (sMBS2, sMBS3, . . . , sMBSn) for serving a UE 30 (UE1). In one example, the message M1 transmitted by the requesting node 10 contains explicit information about the sMBS 40 which is to be configured by the configuration node 20. In this case, the information may include, for example, at least an identifier of a requested sMBS 40. In another example, the message M1 transmitted by the requesting node 10 contains information about the type of service expected to be provided by the sMBS 40 which is to be selected and configured by the configuration node 20.

For example, the communication service expected to be provided by the sMBS may include an enhanced mobile broadband service, an ultra-reliable, low latency communication service, a machine type communication service, a location service, and/or a vehicle-to-anything, V2X, communication service.

In one example, the set of sMBSs out of which at least one sMBS is selected by the configuration node 20 may be pre-defined, and the corresponding information is known to both the requesting node 10 and the configuration node 20. In another example, the information about the set of sMBSs or the available set of sMBSs is provided (or updated) by the configuration node 20 to the requesting node 10.

In an example, the configuration node 20 may maintain and manage the set of sMBSs, in which case the configuration node 20 may be referred to as an MBS management node. The management function performed by an MBS management node may include receiving a request from the requesting node 10, configuring an sMBS out of the set of sMBSs, and directing the configured sMBS to serve the UE.

Prior to transmitting the message M1 to the configuration node 20, the requesting node 10 may determine a need for sMBS service and/or a type of sMBS needed, and/or a type of the service needed to serve UE1. The determination can be based, for example, on autonomously determining the need for sMBS service, the type of sMBS and/or the type of the service.

In one example the requesting node 10 is a UE, such as UE1 or another UE. For example, UE1 may autonomously determine that it needs to be served by sMBS and directly sends a request to the configuration node 20. In another example, the requesting node 10 is a network node such as an access point, base station, core network node such as AMF, MME, etc. In this case, in one example, the requesting node Node1 may autonomously determine a need for the UE to be served by an sMBS, and sends a request directly to the configuration node 20.

For example, FIG. 3 illustrates an embodiment in which the requesting node 10 is the UE (UE1) for which sMBS configuration is requested. In that case, UE1, acting as the requesting node 10, sends a message M1 to the configuration node 20 requesting configuration of an sMBS to serve itself. The message M1 may include information indicating a specific sMBS to be configured and/or information about a type of service needed by the UE.

Referring to FIG. 4, in some embodiments, the determination of the need for sMBS service, the type of sMBS and/or the type of the service can be made based on information received from an information node 50 (Node3), which may, for example, be a UE (e.g. UE1 or UE2) or a radio network node (e.g. base station serving UE1).

When the requesting node 10 is a network node, the requesting node 10 may determine the need for UE1 30 to be served by an sMBS based on information received in a message M3 from the information node 50. The information node 50 may be a UE or another network node, such as a base station. In one example, the information may include information about the sMBS required for serving UE1 30. In that case, the requesting node 10 may forward the received information to the configuration node 20 in a message M1. In another example, the information may include information about the type of service required by UE1 30. In this case, in one example, the requesting node 10 may use the received service information to further determine the type of sMBS out of the set of sMBSs that can serve or manage UE1 30 and transmits information about the type of sMBS to the configuration node 20.

The requesting node 10 and the information node 50 may be configured with one or more mapping tables containing mappings of information to sMBS type. The mappings may be based on pre-defined information or information received from another node, such as a DMN. After determining the need for serving one or more UEs by sMBS, the configuration node may use one of the mapping tables to determine the information about the selected sMBS (e.g., sMBS ID). The requesting node 10 then sends a request (a first message (M1)) containing information about at least one selected sMBS to the configuration node 20. The requesting node 10 may also send a request (in the same message (M1) or different messages, e.g. in M11, M12, etc.) containing information about a plurality of the selected sMBSs to the configuration node 20.

The information may further contain additional information about the UE 30 and/or the sMBS 40. Examples of such additional information include information about an area or location information where the sMBS 40 needs to serve the UE 30, a time instance when the sMBS 40 should start operation, a duration over which the sMBS 40 is expected to serve the UE and/or a mobility profile of the sMBS 40.

The area or location information where sMBS 40 needs to serve the UE 30 may include, for example, 2 or 3-dimensional geographical coordinates, and/or a reference location (e.g., an area between an indicated set of cells).

The time instance (Ts) when the sMBS 40 should start operation may include, for example, a time instance when the sMBS 40 is to start serving the UE 30, and/or a time instance when the sMBS 40 should arrive at the indicated coverage area. The time instance can be expressed with respect to a reference time (Tr), e.g., the sMBS should start no later than Ts after Tr. Examples of reference time are System Frame Number (SFN)=0, UTC time, Global Navigation Satellite System (GNSS) time, etc.

The duration over which the sMBS 40 is expected to serve the UE 30 may be expressed in terms of additional parameters, such as a minimum service duration (DEmin), maximum service duration (DEmax), mean service duration (DEmean), etc.

The mobility profile of the sMBS 40 may include, for example, a speed with which the sMBS 40 is expected to travel when serving the UE 30, and/or a trajectory or path over which the sMBS 40 is required to serve the UE 30.

In one example the sMBS 40 may have to remain static or operate at low speed where the UE 30 and/or other UEs to be served are mainly stationary. In another example the sMBS 40 may have to move or operate at higher speed where at least some UEs are moving, such as in a scenario where vehicular UEs are on a motorway, racing events where UEs are equipped in vehicles, etc.

The trajectory or path over which the sMBS 40 is required to serve the UE 30 may include a set of geographical coordinates covering a path or track or road.

If multiple mapping tables are configured (e.g. pre-defined and/or configured by the configuration node 20) then the requesting node 10 may further specify the table used for requesting the sMBS 40.

Tables 1-5 illustrate various examples of mappings between different specialized types of sMBSs and their respective purposes.

Table 1 is a general example of a mapping table containing a list of N number of sMBSs in a set. The set includes at least one general purpose MBS (sMBS1) and (N−1) specialized sMBSs (sMBS2-sMBSN). A general purpose sMBS is capable of all or most functions required for serving UEs, such as an eMBB service. However, a general purpose sMBS may not be able to guarantee a high quality of service for a specific service, such as UE positioning. The (N−1) sMBSs on the other hand may ensure that the UEs are served with their respective supported specialized services while meeting the quality of service targets. Each of the (N−1) specialized sMBSs may also provide the basic services (such as mobility) needed to serve the UEs. A specialized sMBS may also be capable of providing more than one specialized function or service.

TABLE 1
A general example of a set of N number of
sMBSs managed by Configuration Node (DMN)

| ID | sMBS type | Purpose |
|---|---|---|
| 0 | sMBS1 | General Purpose |
| 1 | sMBS2 | Purpose(s) X1 |
| . . . | . . . | . . . |
| (N − 1) | sMBS_{N} | Purpose(s) X_{N-1} |

Table 2 is a specific example of a mapping table containing a list of 11 different types of sMBS. This set also comprises at least one general purpose MBS (sMBS1) and specialized sMBSs (sMBS2-sMBS10). The table further provides an overview of specialized sMBS. For example, sMBS2 specializes in cell change operations such as enhanced handover. Examples of enhanced handovers are RACH-less HO (i.e., a handover that does not require a random access channel, or RACH, procedure), make before break handover, larger number of RACH resources (e.g. more frequent slots for RACH) to speed up RACH at HO etc.

In another example, sMBS5 specializes in vehicular positioning such as capable of determining the vehicular UE (e.g., a car) location with an accuracy in order of 10-50 decimeters. This requires sMBS5 to transmit to the UE and/or receive from the UE reference signals for positioning with very high density and process them more accurately and quickly. In yet another example, sMBS6 specializes in providing URLLC type services which require the sMBS to implement very advance receiver to enhance the reception quality of the UE signal and also very high processing capability to reduce latency. Similarly, the examples of sMBS7 and sMBS8 are equipped with features to serve UEs with very high data rate (e.g., higher capacity) and extended UE coverage respectively.

TABLE 2
A specific example of a set of 11 different types of sMBS managed by Configuration Node (DMN)

| ID | sMBS type | Purpose |
|---|---|---|
| 0 | sMBS1 | General purpose; support all basic functions |
| 1 | sMBS2 | Specializing in UE mobility e.g. enhanced handover, cell change, cell reselection |
| 2 | sMBS3 | Specializing in UE positioning e.g. accurate location of UE for emergency services. |
| 3 | sMBS4 | Specializing in beamforming function e.g. support larger number of antennas |
| 4 | sMBS5 | Specializing in vehicular positioning e.g. accurate location of vehicle for V2X operation |
| 5 | sMBS6 | Specializing in ultra-high reliability and/or ultra-low latency |
| 6 | sMBS7 | Specializing in very high capacity such as very high UE data rate e.g. supports very large BW |
| | | per carrier, multiple carriers, higher order modulation (e.g. 256QAM, 1024QAM) |
| 7 | sMBS8 | Specializing in serving UE with extended coverage e.g. with pathloss 20 dB higher than the |
| | | maximum pathloss with which sMBS1 can serve the UEs. |
| 8 | sMBS9 | Specializing in extended reality e.g. AR, VR, etc. |
| 9 | sMBS10 | Specializing in sensing and/or in joint communication and sensing (JCAS) |
| 10 | sMBS11 | Specializing in national security and public safety (NSPS) service e.g. provided very high |
| | | power |

Table 3 is another general example of a mapping table containing a list of M number of sMBSs in a set. In Table 3, each type of sMBS is associated with certain endurance level, such as a maximum duration over which it can operate. For simplicity each type of sMBS in this table comprises two endurance levels: short duration (DES) and long duration (DEL). As an example: DES≤T0 and DEL≤T1. The duration can be expressed in terms of suitable time units, such as milliseconds, seconds, number of slots, number of frames, number of SFN or hyper SFN cycles, etc. For example: T0=30 minutes, T0=103*SFN cycles; T1=5 hours, T1=106*SFN cycles etc. For example, an sMBS with short endurance can operate using renewable energy source such as electric battery. However, the embodiment is applicable to non-limiting number of endurance levels, e.g., very low, low, medium, high, very high, etc.

TABLE 3
A general example of a set of M (M = 2*N)
number of sMBSs operating with different endurance
levels, managed by Configuration Node (DMN)

| | | | sMBS operational |
|---|---|---|---|
| ID | sMBS type | Purpose | endurance/duration (D_{E}) |
| 0 | sMBS10 | General Purpose | Short |
| 1 | sMBS11 | General Purpose | Long |
| 2 | sMBS20 | Purpose(s) X1 | Short |
| 3 | sMBS21 | Purpose(s) X1 | Long |
| . . . | . . . | . . . | . . . |
| (M − 2) | sMBS_{N0} | Purpose(s) X_{N-1} | Short |
| (M − 1) | sMBS_{N1} | Purpose(s) X_{N-1} | Long |

Table 4 is yet another general example of a mapping table containing a list of M number of sMBSs in a set. But in this example, each type of sMBS is associated with certain maximum speed, such as a maximum speed with which it can operate. For simplicity, each type of sMBS in this table comprises two speed levels: low speed (SL) and high speed (SH). As an example, SL≤S0 and SH≤S1. The speed can be expressed in terms of suitable speed metric, such as distance/unit time, Doppler frequency, etc. For example: S0=10 km/hour, S0=6 Hz in Doppler frequency; S1=100 km/hour, S1=30 GHz in Doppler frequency etc. The embodiment is applicable to non-limiting number of speed levels/limits, such as very low, low, medium, high, very high, etc.

TABLE 4
A general example of a set of M (M = 2*N)
number of sMBSs operating with different speed
levels, managed by Configuration Node (DMN)

| | | | sMBS maximum |
|---|---|---|---|
| ID | sMBS type | Purpose | speed limit (S) |
| 0 | sMBS10 | General Purpose | Low |
| 1 | sMBS11 | General Purpose | High |
| 2 | sMBS20 | Purpose(s) X1 | Low |
| 3 | sMBS21 | Purpose(s) X1 | High |
| . . . | . . . | . . . | . . . |
| (M − 2) | sMBS_{N0} | Purpose(s) X_{N-1} | Low |
| (M − 1) | sMBS_{N1} | Purpose(s) X_{N-1} | High |

Table 5 is yet another general example of a mapping table containing a list of M number of sMBSs in a set. This example is a combination of examples in Tables 3 and 4. Therefore, each type of sMBS is associated with certain maximum speed and maximum endurance.

TABLE 5
A general example of a set of 8 different types of sMBS operating
with combination of different endurance levels and different
speed levels, managed by Configuration Node (DMN)

| | | | sMBS maximum | sMBS |
|---|---|---|---|---|
| ID | sMBS type | Purpose | speed limit | endurance |
| 0 | sMBS10 | General Purpose | Low | Low |
| 1 | sMBS11 | General Purpose | Low | High |
| 2 | sMBS12 | General Purpose | High | Low |
| 3 | sMBS13 | General Purpose | High | High |
| 4 | sMBS20 | Purpose(s) X1 | Low | Low |
| 5 | sMBS21 | Purpose(s) X1 | Low | High |
| 6 | sMBS22 | Purpose(s) X1 | High | Low |
| 7 | sMBS23 | Purpose(s) X1 | High | High |

According to some further embodiments, upon receiving a request message M1 from the requesting node 10 for providing at least one sMBS, the configuration node 20 executes one or more procedures. Examples of such procedures include selecting or determining the sMBS based on the received request from the requesting node 10 and one or more mapping tables e.g. comparing requested ID and sMBS type in Table 2, activating or preparing the selected sMBS for operation, configuring or directing the selected sMBS (after activation if it was inactivated) for moving to a target area (e.g. location) to serve the UEs, and/or requesting another node (e.g., a second DMN (DMN2)) to provide the requested sMBS in case such sMBS is not available at the requesting node 10.

The configuration node 20 may also decide not to send the sMBS for serving the UEs in the target area, for example, because of the cost for serving the UEs, unavailability of a suitable sMBS, or other reason.

The configuration node 20 may also send a second message (M2) to the requesting node 10 informing the requesting node 10 about any one or more of the above actions or procedures executed or performed by the configuration node 20.

The configuration node 20 can interact with one or more other nodes to improve overall throughput, coverage and QoS for sMBS operations. To support this, an sMBS area can be defined that consists of one or several target areas, configuration nodes and sMBS.

Information can be exchanged within the sMBS area about current or expected sMBS status between nodes. Examples of such information include load levels of sMBSs (e.g. number of UEs being served by sMBSs), cells being served or expected to be served by sMBSs, channel characteristics of sMBSs serving UEs (e.g. interference, radio environment such as urban or rural areas, etc.), locations for sMBSs and target areas being served or expected to be served by sMBSs, etc.

The configuration node 20 can involve other base stations, mobility management control or other nodes for handling of enhanced functions for improving radio characteristics and coverage, such as carrier aggregation, coordinated multipoint or dual connectivity.

The overall optimization of sMBS operation and its availability on demand can be realized with any of a centralized approach, a distributed approach or combination thereof.

FIG. 5 illustrates a centralized approach. As shown therein, in a centralized approach, a master configuration node 20M may be defined for handling a set of sMBSs covering one or several target areas (TAs) which are also associated with their respective configuration nodes. Other configuration nodes act as secondary configuration nodes 20S. The master configuration node 20M will make decisions about how the sMBS should be utilized from an optimal point of view for the sMBS area. The master configuration node 20M sends instructions to secondary configuration nodes for execution of overall optimization decisions of sMBSs.

For example, as shown in FIG. 5, a requesting node 10 may send a message M1a to the master configuration node 20M requesting configuration of an sMBS. Upon receipt of the message, the master configuration node 20M may determine that a secondary configuration node 20S should perform the configuration. In that case, the master configuration node 20M may send a message M1b to the secondary configuration node 20S requesting that the secondary configuration node 20S perform the configuration. The message M1b may include any information, such as identity of a desired sMBS, a description of the type of service required, etc., that is received from the requesting node 10 in the message M1a. The message M1b may include additional information provided by the master configuration node 20M to assist with the configuration by the secondary configuration node 20S.

The secondary configuration node 20S evaluates the configuration request and responds to the master configuration node 20M with a message M2a that confirms or rejects the request. The master configuration node 20M forwards the response to the requesting node 10 in a message M2b, possibly along with additional information provided by the master configuration node 20M.

In a decentralized or distributed approach, each configuration node 20 within the sMBS area exchanges status information about sMBSs 40. Any configuration node 20 can message another configuration node for requesting configuration of sMBSs that could support a request made by a requesting node 10. This means that if every configuration node 20 involved has the same type of optimization algorithms, then their operation in terms of providing the relevant sMBS will lead to the same or similar level of sMBS performance, such as similar optimization of throughput in the sMBS area. The optimizations will gradually converge towards an optimal solution.

Some of the above procedures executed by configuration nodes are further elaborated below.

Selecting sMBS

Referring again to FIG. 2, the configuration node 20 may select or determine an sMBS 40 as requested by the requesting node 10 according to one or more of the following principles.

In one example, the configuration node 20 may select the same type of sMBS as requested by the requesting node 10. This mechanism can be realized if the requested sMBS type is available for operation at the configuration node 20.

In another example, the configuration node 20 may select a sMBS 40 whose functions are similar to or closest to the type of sMBS as requested by the requesting node 10. This mechanism can be used if the requested sMBS type is not available for operation at the configuration node 20. The requested sMBS 40 may not be available due to one or more reasons, such as because it is serving another set of UEs, because the sMBS 40 needs to be activated but is requested to be sent immediately or within short time, and/or because the requested sMBS 40 is malfunctioning, etc. For example, if the requested sMBS3 in Table 2 (specializing in UE positioning) is not available, then the configuration node 20 may select sMBS5 in Table 2.

In yet another example, the configuration node 20 may select a reference sMBS if the requested sMBS type is not available for operation at the requested location. Examples of a reference sMBS include a pre-determined type of sMBS (e.g., agreed between the requesting node 10 and the configuration node 20), a general purpose sMBS (e.g., sMBS1 in Table 1 or 2), a general purpose sMBS with certain endurance and/or with certain speed (e.g., sMBS10-sMBS13 in Table 3, 4 or 5).

In the above examples, the configuration node 20 further uses additional information received from the requesting node 10, such as duration of operation and/or speed of sMBS 40, time instance when the sMBS 40 is needed, etc., for selection of the sMBS 40. For example, if the duration is short and expected speed is low and the requested sMBS type is general purpose, then the configuration node 20 selects sMBS10 in Table 5.

Activating an sMBS

The requested sMBS 40 may or may not be active at the time of receiving the request at the configuration node 20. For example, as shown in Table 6, the operational state of an sMBS 40 can be active or inactive. The terms “active state” and “inactive state” may also be referred to as ON state and OFF state, respectively. For example, to save power and/or reduce heat or lower temperature, an sMBS 40 that is not used for some time (e.g. used over more than Tu time units) can be relegated to inactive state. If the sMBS 40 is in ‘active state’ then the configuration node 20 can configure or direct that sMBS 40 to move immediately to the requested location or area to serve the UEs (as requested by the requesting node 10). But if the sMBS 40 is in ‘inactive state,’ then the configuration node 20 first changes the state of the sMBS 40 from inactive to active by, for example, sending a signal or message to that sMBS 40. The sMBS 40 may need a certain amount of time until it becomes fully active. Once the sMBS 40 is active, then the configuration node 20 will trigger that sMBS to move to the location of the target area to serve the UEs.

TABLE 6
A specific example of a set of N different types
of sMBS managed by Configuration Node (DMN)

| ID | sMBS type | Purpose | Operational state |
|---|---|---|---|
| 0 | sMBS1 | General Purpose | Active/inactive |
| 1 | sMBS2 | Purpose(s) X1 | Active/inactive |
| . . . | . . . | . . . | . . . |
| (N − 1) | sMBS_{N} | Purpose(s) X_{N-1} | Active/inactive |

Directing sMBS to Target Area

The configuration node 20 may configure the sMBS 40 with the information about the target area (e.g., geographical coordinates, etc.) where that sMBS 40 is required to serve the UE 30. The configuration node 20 may further configure the sMBS 40 with additional information related to the duration of operation and/or mobility profile (e.g., speed, trajectory, etc.) with which the sMBS 40 is required to operate in the target area. This will allow the sMBS 40 to optimize its resources, such as fuel, battery level, etc., to ensure operation for the indicated time duration. The configuration node 20 may further configure the sMBS 40 with information about the time instance by which the sMBS 40 should reach or become available at the target area. This will allow the sMBS 40 to adapt its speed with which it has to move and arrive at the target area in a timely manner.

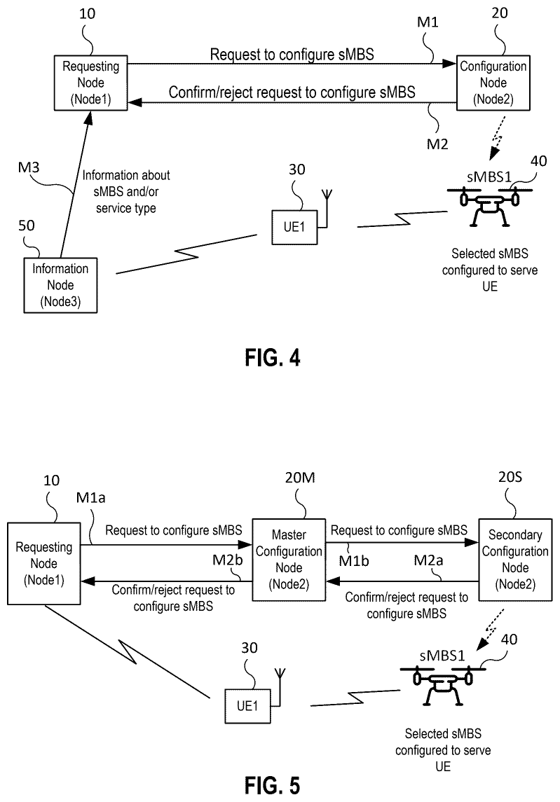

FIG. 6 illustrates a method performed by a requesting node 10 in a wireless communication network according to some embodiments. Referring to FIGS. 2-5 and 6, the method includes determining a need for a mobile base station 40 to provide wireless communication services to a UE 30 in a target geographic area (block 602), and transmitting a request message M1 to a configuration node 20 that is responsible for configuring mobile base stations in the target geographic area (block 604). The request message M1 requests the configuration node 20 to configure at least one mobile base station 40 out of a set of mobile base stations 40 for serving the UE 30 in the target geographic area.

The method may further include receiving a response message M2 from the configuration node 20 indicating whether or not the request to configure the at least one mobile base station 40 was successful.

The request message M1 may include information about a mobile base station 40 that is to be configured by the configuration node 20. For example, the information may include an identifier of a requested mobile base station 40.

In some embodiments, the request message M1 indicates a type of communication service expected to be provided by the at least one mobile base station to the UE 30 in the target geographic area. The type of communication service expected to be provided by the mobile base station 40 may include an enhanced mobile broadband service, an ultra-reliable low-latency communication service, a machine type communication service, a location service, a vehicle-to-anything (V2X) communication service, a national security and public safety (NSPS) service, a massive machine type communication service, a low-latency high-rate service, a cloud gaming service, an extended reality service, an advance duplex operational service, a sensing service and/or a joint communication and sensing (JCAS) service.

The JCAS service may also be referred to as a radar service, which enables detection or identification of an object (e.g. human, vehicle, etc.) by means of transmitting sensing/radar signals e.g. between a UE and a mobile base station. The JCAS service enables detection or identification of an object while still enabling the UE to maintain a communication service (e.g. eMBB, etc.).

The extended reality (XR) service enables high quality communication (e.g. real time high quality video). Examples of XR are augmented reality (AR), virtual reality (VR), etc.

An advance duplex service enables efficient use of the radio spectrum by reusing the spectrum usage in different transmission directions but requires more complex implementation in the device. Examples of advance duplex are dynamic or flexible duplex, full duplex etc. For example, in flexible duplex, the device can dynamically change the direction (uplink or downlink) of a slot from one frame to another. In another example, in full duplex, the device can simultaneously transmit and receive signals at the same time in the same frequency resource (e.g. resource block).

A mobile base station supporting NSPS may support very high output power (e.g. 46 dBm) and/or robust to withstand natural disasters (e.g. hurricanes, forest fires, etc.) or manmade disasters.

The request message M1 may indicate the target geographic area, a type of mobile base station 40 needed, a reference time at which the at least one mobile base station 40 should start providing communication services to the UE 30 in the target geographic area, a time duration during which the at least one mobile base station 40 should provide communication services to the UE 30 in the target geographic area, and/or a mobility profile that is needed for the at least one mobile base station 40 to provide communication services to the UE 30 in the target geographic area.

The method may further include receiving additional information from an information node 50 about the at least one mobile base station 40, a type of mobile base station 40 to be configured, and/or a type of service to be provided to the UE in the target geographic area.

Referring to FIGS. 2-5 and 7, a method performed by a configuration node 20 that is responsible for configuring mobile base stations in a target geographic area in a wireless communication network is illustrated. The method includes receiving a request message M1 from a requesting node 10 that requests the configuration node 20 to configure at least one mobile base station 40 out of a set of mobile base stations to provide wireless communication services to a UE in the target geographic area (block 702), and configuring the at least one mobile base station 40 to provide wireless communication services to the UE 30 in the target geographic area (block 704).

The method may further include transmitting a response message M2 to the requesting node confirming configuration of the at least one mobile base station 40. The request message may include information about a mobile base station 40 that is to be configured by the configuration node.

The request message may include information about a mobile base station 40 that is to be configured by the configuration node 20, and the method may further include selecting the at least one mobile base station 40 to provide communication services to the UE 30 based on the information.

The method may further include transmitting a secondary request to a secondary configuration node 20S requesting the secondary configuration node 20S to configure the at least one mobile base station.

The method may further include executing a procedure in response to receiving the request message, wherein the procedure comprises selecting the at least one mobile base station based on a mapping table, activating or preparing the at least one mobile base station, configuring or directing the at least one mobile base station to move to the target geographic location, and/or requesting a secondary node to configure the at least one mobile base station.

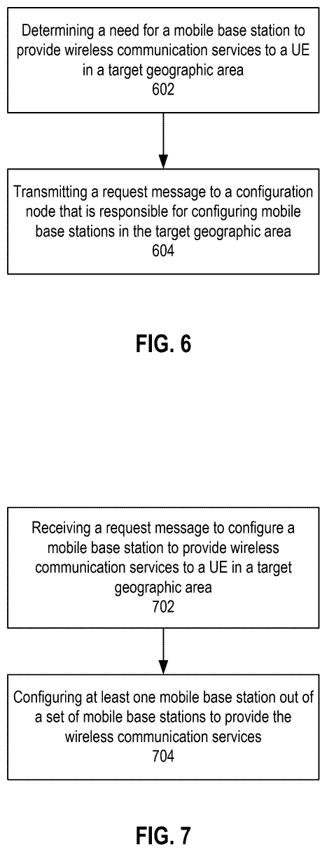

FIG. 8 shows an example of a communication system 100 in accordance with some embodiments.

In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

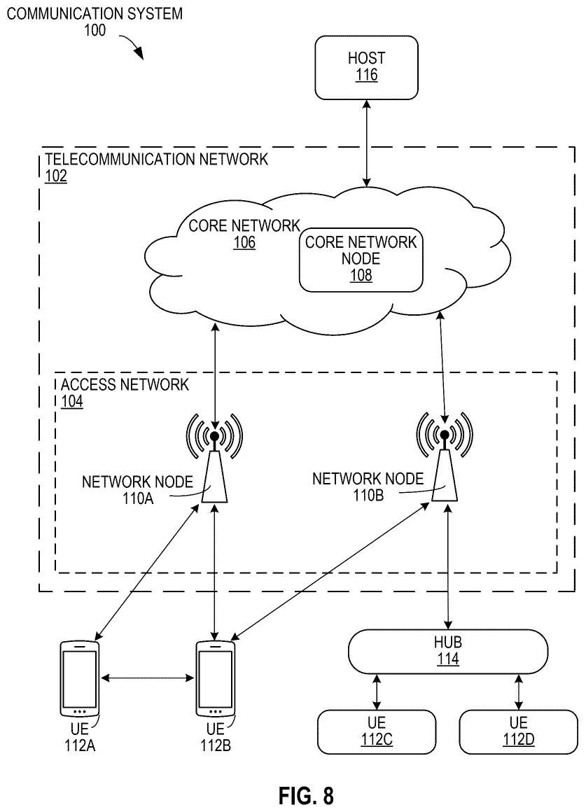

FIG. 9 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a helicopter drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a vehicle and provide the vehicle's speed information (obtained through a speed sensor) to a second UE that is a remote controller operating the vehicle. When the user makes changes from the remote controller, the first UE may adjust the throttle on the vehicle (e.g. by controlling an actuator) to increase or decrease the vehicle's speed. The first and/or the second UE can also include more than one of the functionalities described above. For example, a UE might comprise the sensor and the actuator, and handle communication of data for both the speed sensor and the actuators.

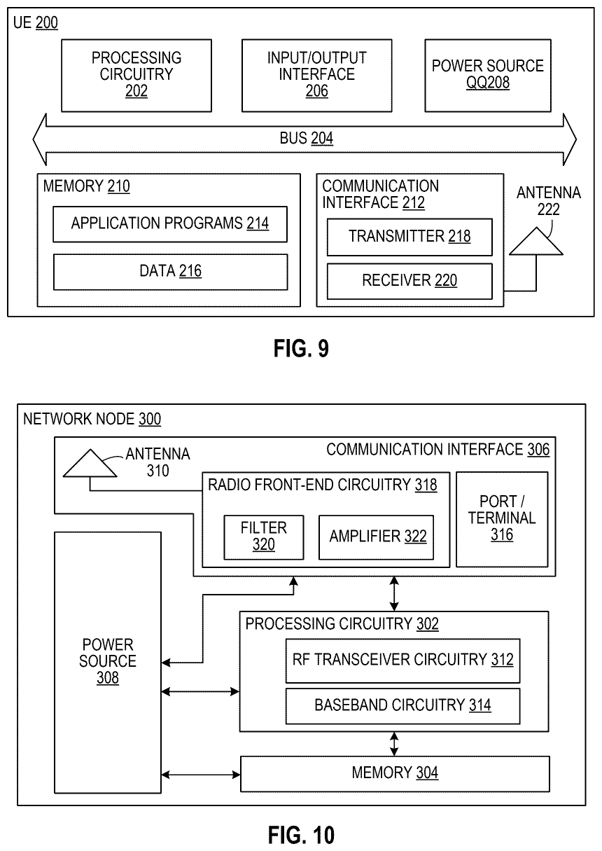

FIG. 10 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (Aps) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 10 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method performed by a node in a wireless communication network, comprising:
determining a need for a mobile base station to provide wireless communication services to a user equipment, UE, in a target geographic area; and
transmitting a request message to a configuration node that is responsible for configuring mobile base stations in the target geographic area, wherein the request message requests the configuration node to configure at least one mobile base station out of a set of mobile base stations for serving the UE in the target geographic area.

2. The method of claim 1, further comprising:
receiving a response message from the configuration node indicating whether or not the request to configure the at least one mobile base station was successful.

3. The method of claim 1, wherein the request message comprises information about a mobile base station that is to be configured by the configuration node.

4. The method of claim 3, wherein the information comprises an identifier of the mobile base station that is to be configured by the configuration node.

5. The method of claim 3, wherein the request message indicates a type of communication service expected to be provided to the UE in the target geographic area by the mobile base station that is to be configured by the configuration node.

6. The method of claim 5, wherein the type of communication service expected to be provided by the mobile base station comprises an enhanced mobile broadband service, an ultra-reliable low-latency communication service, a machine type communication service, a location service, a vehicle to anything communication service, a national security and public safety service, a massive machine type communication service, a low-latency high-rate service, a cloud gaming service, an extended reality service, an advance duplex operational service, a sensing service and/or a joint communication and sensing service.

7. The method of claim 1, wherein the request message indicates the target geographic area.

8. The method of claim 1, wherein the request message indicates a type of mobile base station needed.

9. The method of claim 1, wherein the request message indicates a reference time at which the at least one mobile base station should start providing communication services to the UE in the target geographic area.

10. The method of claim 1, wherein the request message indicates a time duration during which the at least one mobile base station should provide communication services to the UE in the target geographic area.

11. The method of claim 1, wherein the request message indicates a mobility profile that is needed for the at least one mobile base station to provide communication services to the UE in the target geographic area.

12. The method of claim 1, further comprising:
receiving additional information from an information node about the at least one mobile base station, a type of mobile base station to be configured, and/or a type of service to be provided by the at least one mobile base station.

13. The method of claim 12, further comprising including the additional information in the request message transmitted to the configuration node.

14. (canceled)

15. A method performed by a node in a wireless communication network, comprising:
receiving, at a configuration node that is responsible for configuring mobile base stations in a target geographic area, a request message from a requesting node, wherein the request message requests the configuration node to configure at least one mobile base station out of a set of mobile base stations to provide wireless communication services to a user equipment, UE, in the target geographic area; and
configuring the at least one mobile base station to provide wireless communication services to the UE in the target geographic area.

16. The method of claim 15, further comprising transmitting a response message to the requesting node confirming configuration of the at least one mobile base station.

17. The method of claim 15, wherein the request message comprises an identifier of a mobile base station that is to be configured by the configuration node.

18. (canceled)

19. The method of claim 15, wherein the request message indicates a mobility profile that is needed for the at least one mobile base station to provide communication services to the UE in the target geographic area.

20. (canceled)

21. (canceled)

22. The method of claim 15, wherein the request message indicates at least one of: the target geographic area; a type of communication service expected to be provided by the at least one mobile base station to the UE in the target geographic area; a type of mobile base station needed; a reference time at which the at least one mobile base station should start providing communication services to the UE in the target geographic; and a time duration during which the at least one mobile base station should provide communication services to the UE in the target geographic area.

23.-31. (canceled)

32. A node in a wireless communication network, comprising:
a processing circuit; and
a memory coupled to the processing circuit, wherein the memory comprises computer readable program instructions that, when executed by the processing circuit, cause the node to perform operations to:
determine a need for a mobile base station to provide wireless communication services to a user equipment, UE, in a target geographic area; and
transmit a request message to a configuration node that is responsible for configuring mobile base stations in the target geographic area, wherein the request message requests the configuration node to configure at least one mobile base station out of a set of mobile base stations for serving the UE in the target geographic area.

33. (canceled)

34. A node in a wireless communication network, comprising:
a processing circuit; and
a memory coupled to the processing circuit, wherein the memory comprises computer readable program instructions that, when executed by the processing circuit, cause the node to perform operations to:
receive, at a configuration node that is responsible for configuring mobile base stations in a target geographic area, a request message from a requesting node, wherein the request message requests the configuration node to configure at least one mobile base station out of a set of mobile base stations to provide wireless communication services to a user equipment, UE, in the target geographic area; and
configure the at least one mobile base station to provide wireless communication services to the UE in the target geographic area.
